(19) United States
(12) Patent Application Publication
(10) Pub. No.: US 2006/0074873 A1
(43) Pub. Date: Apr. 6, 2006

(54) Extending data access and analysis capabilities via abstract, polymorphic functions

(75) Inventors: Richard D. Dettinger, Rochester, MN (US); Daniel P. Kolz, Rochester, MN (US); Richard J. Stevens, Rochester, MN (US); Jeffrey Wayne Tenner, Rochester, MN (US)

Correspondence Address: William J. McGinnis, Jr.;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/955,726

(22) Filed: Sep. 30, 2004

(51) Int. Cl. G06F 17/30

(52) U.S. Cl. 707/3

(57) ABSTRACT

An abstract database is an effective way to reduce the complexity of a large database management system. Abstract databases allow a user to compose queries based on the logical relationships among data items, without requiring a user to understand the underlying database schema used to store the data in the database system. Embodiments of the invention generally provide methods, systems, and articles of manufacture that extend the capabilities of an abstract database to include “late bound” polymorphic functions in an abstract data layer. Abstract functions are “late bound” because the function definition (i.e., the execution logic) is not determined until the function is actually invoked. They are polymorphic because same function may operate using many different many data input types. Additionally, abstract functions are generally transparent to the end user. That is, they are presented to the user as an additional object that may be used to compose queries of data represented by the abstract data layer undifferentiated from other data elements used to compose an abstract query.

### CROSS-REFERENCE TO RELATED APPLICATIONS

This application is related to commonly owned co-pending applications “Application Portability and Extensibility Through Database Schema and Query Abstraction,” Ser. No. 10/083,075, filed Feb. 26, 2002 and “Remote Data Access and Integration of Distributed Data Sources through Data Schema and Query Abstraction,” Ser. No. 10/131,984, filed Apr. 25, 2002, both of which are incorporated by reference herein in their entirety.

### BACKGROUND OF THE INVENTION

1. Field of the Invention

The present invention generally relates to computer databases. More specifically, the invention relates to extending abstract database techniques to provide polymorphic, abstract functions to users of an abstract database.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways.

Regardless of the particular architecture, in a DBMS, a requesting entity (e.g., an application, operating system or end-user) demands access to a specified database by issuing a database access request. Such requests may include, for instance, simple catalog lookup requests or transactions and combinations of transactions that read, change and add specified records in the database. These requests are made using high-level query languages such as Structured Query Language (SQL). Illustratively, SQL is used to construct a query that retrieves information from and updates information in a database. Known databases include International Business Machines' (IBM) DB2®, Microsoft's® SQL Server, and database products from Oracle®, Sybase®, and Computer Associates®. The term “query” referrers to a set of commands composed to retrieve data from a stored database. Queries take the form of a command language that lets programmers and programs select, insert, update, determine the location of data, and the like.

One of the issues faced by data mining and database query applications, in general, is their close relationship with a given database schema (e.g., a relational database schema). This relationship makes it difficult to support an application as changes are made to the corresponding underlying database schema. Further, it inhibits the migration of the application to alternative underlying data representations. In today's environment, the foregoing disadvantages are largely due to the reliance applications have on SQL, which presumes that a relational model is used to represent information being queried. Furthermore, a given SQL query is dependent upon a particular relational schema, because specific database tables, columns and relationships are referenced by an SQL query. As a result of these limitations, a number of difficulties arise.

One difficulty is that changes in the underlying relational data model require changes to the relational schema upon which the corresponding application is built. Therefore, an application designer must either forgo changing the underlying data model to avoid application maintenance or must change the application to reflect changes in the underlying relational model. Another difficulty is that extending an application to work with multiple relational data models requires separate versions of the application to reflect the unique SQL requirements of each relational schema. Yet another difficulty is evolving the application to work with alternate data representations because SQL is specifically designed for use with relational systems. Extending the application to support alternative data representations, such as XMLQuery, requires rewriting the application's data management layer to use non-SQL data access methods.

Moreover, the increasing complexity of database systems (and the data stored in such systems) is driving a change in database technology. Specifically, abstraction layers may be used to reduce the complexity faced by a user interacting with a modern database application and DBMS system. Some embodiments of an abstract database provide a data abstraction model, or an abstract data layer, interposed between a user interacting with a query application and an underlying representation used to store data (e.g., a relational database). One embodiment of an abstract data layer provides a set of logical fields that correspond with a users' substantive view of the data. The logical fields are available for a user to compose queries that search, retrieve, add, and modify data stored in the underlying databases. Detailed examples of a data abstraction layer are described in a commonly owned application “Application Portability and Extensibility Through Database Schema and Query Abstraction,” Ser. No. 10/083,075, filed Feb. 26, 2002, incorporated herein by reference in its entirety.

Expressing queries and data requests in abstract terms provides users with a great deal of value; namely, doing so enables users to compose complex queries in understandable terms without being forced to wade through the complexity of the underlying database schema. The elements of an abstract query are connected together by a user in a logical manner based on information relationships between query elements, rather than on the underlying structure of the database. The abstract queries may then be translated into a format that may be processed by a query engine (e.g., an SQL server) against the underlying database.

Once created, however, the abstract layer may be used to store additional information and to deliver additional services to an end user. For example, logical fields may provide a user with information determined using an expression that manipulates data stored in the underlying database to determine a result value for the logical field. The composed field technique allows users to query on concepts at the abstract layer that are not represented in the physical layer. For example, consider the concept of “age.” The abstract layer may compute an “age” based on a birth date or origin date stored the physical model. However, the composition logic defined for the logical field is somewhat fixed, because the composition expression must be explicitly defined in the abstract layer for each composed field. . That is, if one logical field is used to return the age for an individual, another composition would have to be defined for other inputs, e.g., the age of a lab specimen. Thus, while the existing abstract model supports composed content, the actual algorithm or execution logic used to process is not abstractly defined or reusable across multiple concepts or groups of data input types. Accordingly, there remains a need for extensions to abstract database techniques and data analysis methods to include abstract, polymorphic functions.

### SUMMARY OF THE INVENTION

One embodiment of the invention provides a method for extending data access and analysis capabilities of an abstract database using abstract, polymorphic functions. The method generally comprises providing an abstract query specification that defines a plurality of logical fields used to compose an abstract query, wherein the definition for each logical field specifies (i) a name used to identify the logical field, (ii) an access method that maps the logical field to data in an underlying data repository, and wherein the access method specified for at least one logical field comprises a functional access method specifying at least a group of data input types for an abstract function, and wherein the abstract function is bound to a function evaluation method based on a particular group of data input types specified for the abstract function by a particular abstract query.

Another embodiment of the invention provides a method for processing an abstract query that includes a logical field defined over an abstract function. The method generally includes receiving, from a requesting entity, an abstract query composed from a plurality of logical fields defined in a data abstraction layer, wherein the definition for each logical field specifies (i) a name, and (ii) an access method that maps the logical field to data in an underlying data repository, and wherein the access method specified for at least one of the plurality logical fields query specifies a functional access method that specifies a group data input types for an abstract function, and wherein the abstract function is bound to a function evaluation method while processing the abstract query based on the data input types. The method generally further includes transforming the abstract query into a query consistent with a physical representation of the data in the underlying data repository using the access methods specified for each logical field included in the abstract query, binding the abstract function to a function evaluation method invoked to obtain a result value for the at least one logical field, and invoking the function evaluation method to determine a result value for the functional access method.

Another embodiment of the invention provides system configured to process an abstract query. The system generally includes a data abstraction layer configured to provide a set of logical fields used to compose an abstract query; wherein each logical field specifies (i) a name used to identify the logical field, (ii) an access method that maps the logical field to data in an underlying data repository, wherein the access method specified for at least one logical field comprises a functional access method, wherein (i) the definition for the functional access method specifies at least a group of data input types for an abstract function, and wherein (ii) the abstract function is bound to a function evaluation method while processing the abstract query based on a particular group of data input types specified for the abstract function. The system generally further includes a runtime component configured to receive an abstract query, and in response, (i) to generate a query contribution for each logical field included in the abstract query and (ii) to bind the abstract function specified by the at least one logical field to a functional evaluation method based on the particular group of data input types specified for the abstract function.

Another embodiment of the invention provides a computer-readable medium containing a program which, when executed by a processor, performs operations of extending data access and analysis capabilities via abstract, polymorphic functions. The operations generally include, providing an abstract query specification that defines a plurality of logical fields used to compose an abstract query, wherein the definition for each logical field specifies (i) a name used to identify the logical field, (ii) an access method that maps the logical field to data in an underlying data repository, and wherein the access method specified for at least one logical field comprises a functional access method that specifies at least a group of data input types for an abstract function, and wherein the abstract function is bound to a function evaluation method based on the particular group of data input types specified by the abstract query. The operations generally further include, receiving, from a requesting entity, the abstract query composed from a plurality of logical fields, transforming the abstract query into a query consistent with a physical representation of the data in the underlying data repository, binding the abstract function to a function evaluation method invoked to obtain a result value for the at least one logical field, and invoking the function evaluation method to determine the result value for the functional access method.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

Note, however, that the appended drawings illustrate only typical embodiments of the invention and are not, therefore, limiting of its scope, for the invention may admit to other equally effective embodiments.

FIG. 1 illustrates a networked computing system, according to one embodiment of the invention.

FIG. 2A is an illustrative relational view of software components.

FIG. 2B illustrates an abstract query and corresponding data repository abstraction component, according to one embodiment of the invention.

FIG. 3 is a flow chart illustrating the operation of a runtime component, according to one embodiment of the invention.

FIG. 4 is a flow chart further illustrating the operation of a runtime component, according to one embodiment of the invention.

FIGS. 5A, 5B, and 5C illustrate the functional relationships between a logical field, access method, and underlying data source, according to one embodiment of the invention.

FIG. 6 illustrates an abstract query and corresponding data repository abstraction component, according to one embodiment of the invention.

FIG. 7 illustrates a method for processing an abstract query, according to one embodiment of the invention.

FIG. 8 illustrates exemplary graphical user interface screens that may be displayed to a user interacting with an embodiment of the invention.

### DETAILED DESCRIPTION OF THE PREFERRED EMBODIMENTS

### INTRODUCTION

The present invention generally provides methods, systems, and articles of manufacture that extend the capabilities of an abstract database to include “late bound” polymorphic functions in an abstract data layer. Abstract functions are “late bound” because the function definition (i.e., the execution logic) is not determined until the function is actually invoked. They are polymorphic because the same function may operate using many different many data input types. Additionally, abstract functions are generally transparent to the end user. That is, they are presented to the user as an additional object that may be used to compose queries of data represented by the abstract data layer, undifferentiated from other objects provided by the abstract data layer.

In one embodiment, one or more “signatures” are used to define a different input group recognized by the abstract function. The input groups may be defined in terms of other entities defined in a data abstraction layer. For example, an abstract function configured as “distance” might take input logical fields such as points on a map, street addresses, or gene loci. Based on these different inputs (i.e., signatures), such an abstract function would return actual distance, driving distance, or gene linkage. In each case, a numerical value is returned, regardless of which input set was used.

In one embodiment of a data abstraction layer, users may compose an abstract query using a set of logical fields defined by a data abstraction layer. The data abstraction layer, along with an abstract query interface, provides users with an abstract view of the data available to query (i.e., search, select, and modify). The data itself is stored in a set of underlying physical databases using a concrete physical representation (e.g., a relational database). The physical representation may include a single computer system, or may comprise many such systems accessible over computer networks. Where multiple data sources are provided, each logical field may be configured to include a location specification identifying the location of the data to be accessed. A runtime component is configured to resolve an abstract query into a query processed by the underlying physical data repositories.

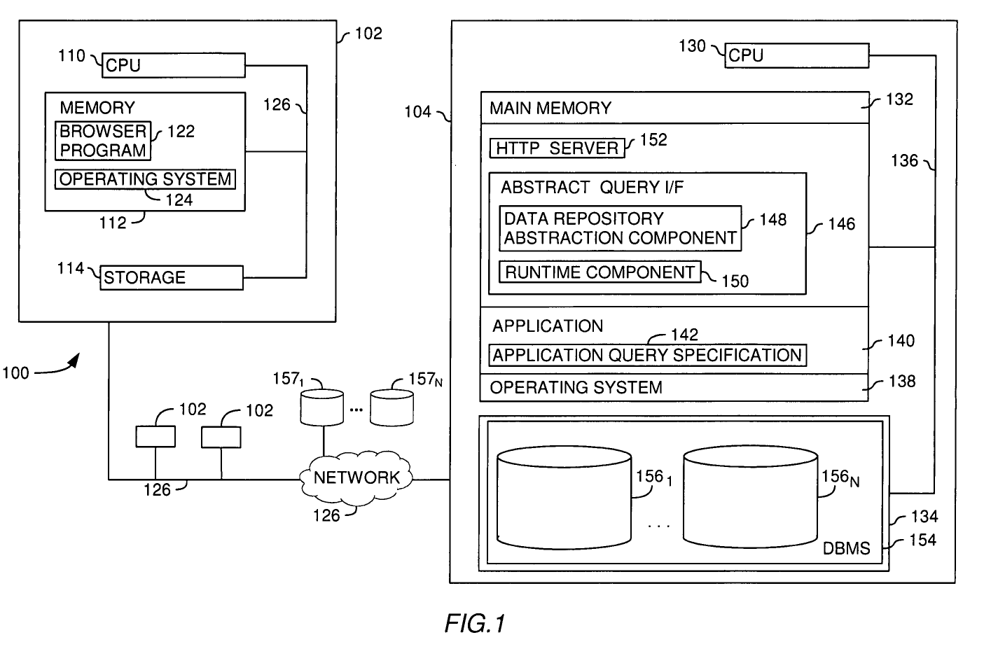

One embodiment of the invention is implemented as a program product for use with a computer system such as, for example, the computer system 100 shown in FIG. 1 and described below. The program product defines functions of the embodiments (including the methods) described herein and can be contained on a variety of signal-bearing media. Illustrative signal-bearing media include, without limitation, (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed across communications media, (e.g., a computer or telephone network) including wireless communications. The latter embodiment specifically includes information shared over the internet and other large computer networks. Such signal-bearing media, when carrying computer-readable instructions that perform methods of the present invention, represent embodiments of the present invention.

In general, software routines implementing embodiments of the invention may be part of an operating system or part of a specific application, component, program, module, object, or sequence of instructions such as a script. The software typically comprises a plurality of instructions capable of being performed using a computer system. Also, programs typically include variables and data structures that reside in memory or on storage devices as part of their operation. In addition, various programs described herein may be identified based upon the application for which they are implemented. Those skilled in the art will recognize, however, that any particular nomenclature or application that follows is used for convenience and does not limit the invention for use solely with a specific application or nomenclature. Furthermore, the functionality of programs described herein use discrete modules or components interacting with one another. Those skilled in the art will recognize that different embodiments may combine or merge such components and modules in many different ways.

Further, in the following, reference is made to embodiments of the invention. The invention is not, however, limited solely to any specifically described embodiment; instead, any combination of the following features and elements, whether related to a particular embodiment described herein, is contemplated to implement and practice the invention. Furthermore, embodiments of the invention provide advantages over the prior art. Although embodiments of the invention may achieve advantages over other possible solutions or over the prior art, whether or not a particular advantage is achieved by a given embodiment is not limiting of the invention. Thus, the following aspects, features, embodiments, and advantages are merely illustrative and neither considered elements nor limitations of the appended claims except where explicitly recited in a specific claim. Similarly, references to “the invention” shall not be construed as a generalization of any inventive subject matter disclosed herein and shall not be considered an element or limitation of the appended claims, except where explicitly recited in a specific claim.

Physical View of Environment

FIG. 1 depicts a block diagram of a networked system 100 in which embodiments of the present invention may be implemented. In general, the networked system 100 includes a client computer 102 (three such client computers 102 are shown) and at least one server computer. The client computer 102 and the server computer 104 are connected via network 126. In general, the network 126 may be a local area network (LAN) and/or a wide area network (WAN). In a particular embodiment, the network 126 is the Internet.

The client computer 102 includes a Central Processing Unit (CPU) 110 connected via a bus 130 to memory 112 and storage 114. Storage 114 is preferably a direct access storage device. Typical such devices include IDE, SCSI, or RAID managed hard drive(s). Although shown as a single unit, it may comprise a combination of fixed and/or removable storage devices, such as fixed disc drives, floppy disc drives, tape drives, removable memory cards, or optical storage. Memory 112 includes memory storage devices that come in the form of chips (e.g., SDRAM or DDR memory modules).

In addition, each of the client computers 102, may include additional components not illustrated in FIG. 1, such as I/O devices (e.g., keyboard, mouse pointer, CD-Rom, USB devices), and may also include other specialized hardware. Further, each client computer 102 is running an operating system, (e.g., a Linux® distribution, Microsoft Windows®, IBM's AIX®, FreeBSD, and the like) to manage interactions between hardware components and higher-level software applications.

As illustrated, FIG. 1 shows memory 112 containing a browser program 122 that provides support for navigating between various servers (e.g. server 104) and sharing data between them. In one embodiment, the browser program 122 comprises a web-based Graphical User Interface (GUI), which allows the user to display Hyper Text Markup Language (HTML) documents (i.e., web-pages). More generally, the browser program 122 may be any GUI-based program capable of rendering the information transmitted from the server computer 104. In addition, memory 112 is illustrated with application programs 125. Application programs 125 may comprise any software program configured to compose, process, and issue abstract queries according to the abstract query specification 142.

The server computer 104 may be physically similar to the client computer 102. Accordingly, the server computer 104 is shown generally comprising a CPU 130, memory 132, and storage device 134, coupled by bus 136. Also, server computer 104, like client computer 102, may include additional components not illustrated in FIG. 1, such as I/O devices (e.g., keyboard, mouse pointer, CD-Rom, USB devices, monitor display and the like), and may also include other specialized hardware. More generally, the client computer 102 and server computer 104 are labeled as such due to their respective function and on the software processes running thereon and not necessarily on any difference in the physical components used to construct each computer system. Thus, server computer 104 is also running an operating system, (e.g., a Linux® distribution, Microsoft Windows®, IBM's AIX®, FreeBSD, and the like) to manage interactions between hardware components and higher-level software applications.

As illustrated in FIG. 1, memory 132 of server computer 104 includes one or more applications 140 and an abstract query interface 146. The applications 140 and the abstract query interface 146 are software products comprising a plurality of instructions that reside in the storage devices in the computer system 104. When read and executed processor(s) 130 in server 104, the applications 140 and the abstract query interface 146 cause the computer system 100 to perform the steps necessary to execute steps or elements embodying the various aspects of the invention. The applications 140 (and more generally, any requesting entity) issue queries against an abstract database. The abstract queries are resolved into queries consistent with the physical representations used to store data, e.g., data stored in local databases 156₁ . . . 156_{N}, and remote databases 157₁ . . . 157_{N}. (Collectively referred to as databases 156-157.) Illustratively, databases 156 are shown as part of a database management system (DBMS) 154 in storage 134. More generally, as used herein, the terms “databases” “data source” or “data repository” refers to any collection of data regardless of the particular physical representation. For example, databases 156-157 may be organized according to a relational schema (accessible by SQL queries) or according to an XML schema (accessible by XML queries). As used herein, the term “schema” generically refers to a particular arrangement of data. The invention is not limited, however, to a particular schema and contemplates extension to schemas presently unknown; rather, the data abstraction layer provides access to an evolving (in terms of schema, location, accessibility, and the like) set of underlying data repositories.

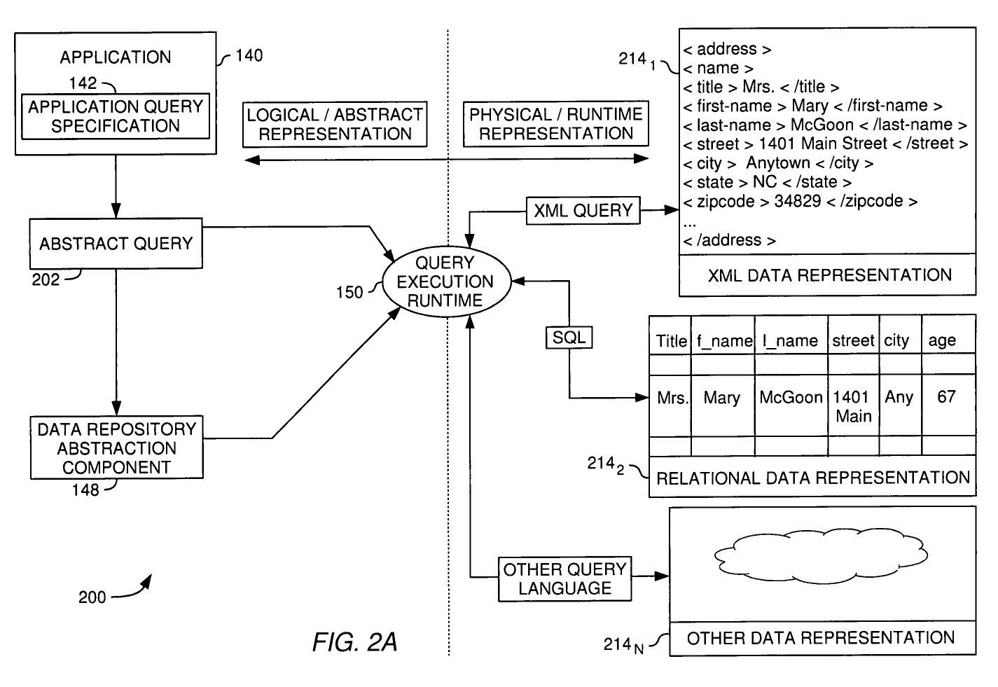

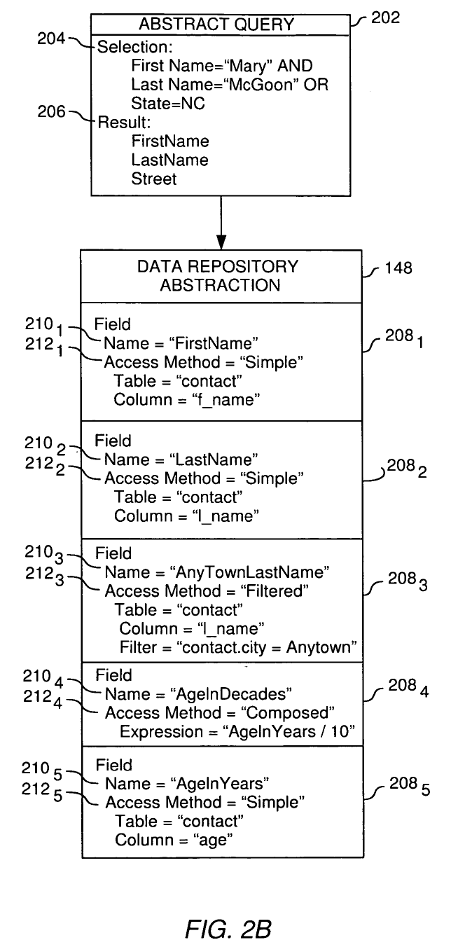

In one embodiment, the queries issued by applications 140 are defined according to an application query specification 142 included with each application 140. The queries issued by the applications 140 may be predefined (i.e., hard coded as part of the applications 140) or may be generated in response to input (e.g., user input). In either case, the queries (referred to herein as “abstract queries”) are composed using logical fields defined by the abstract query interface 146. In particular, the logical fields used in the abstract queries are defined by a data repository abstraction component 148 of the abstract query interface 146. The abstract queries are executed by a runtime component 150 that transforms the abstract queries into a form consistent with the physical representation of the data contained in one or more of the databases 156-157, and returns results to a requesting entity. The application query specification 142 and the abstract query interface 146 are further described with reference to FIGS. 2A-B.

In addition to processing abstract queries by transforming between an abstract representation and an actual representation used by a particular DBMS, the runtime component 150 may process logical fields defined over an abstract function. In one embodiment, a user interacting with an application program 125 or browser program 122 specifies elements of an abstract query. The content rendered by these programs is generated by the application 140. In a particular embodiment, the GUI content is hypertext markup language (HTML) data that may be rendered on the client computer system 102 with the browser program 122. Accordingly, the memory 132 includes a Hypertext Transfer Protocol (HTTP) server process 152 (e.g., a web server such as the open source Apache web-sever program or IBM's WebSphere® program) adapted to service requests from the client computer 102. For example, HTTP daemon 138 may respond to requests to access databases 156, residing on the server 104. Where the remote databases 157 are accessed via the application 140, the data repository abstraction component 148 is configured with a location specification identifying the database containing the data to be retrieved.

Those skilled in the art will recognize that FIG. 1 is merely one hardware and software configuration for the networked client computer 102 and server computer 104, and that embodiments of the present invention can apply to any comparable hardware configuration, regardless of whether the computer systems are complicated, multi-CPU computing systems, single-user workstations, or network appliances without non-volatile storage of their own. Additionally, it is understood that where reference is made to particular markup languages, including HTML, the invention is not limited to a particular language, standard or version. Accordingly, persons skilled in the art will recognize that the invention is adaptable to other markup languages as well as non-markup languages and that the invention is also adaptable future changes in a particular markup language as well as to other languages presently unknown. Likewise, the HTTP server process 152 shown in FIG. 1 is merely illustrative and other embodiments adapted to support any known and unknown protocols for data communications between computer systems are contemplated.

Logical/Runtime View of Environment

FIGS. 2A and 2B illustrate a plurality of interrelated components of the invention. The requesting entity (e.g., one of the applications 140) issues a query 202 consistent with the application query specification 142 of the requesting entity. The resulting query 202 is generally referred to herein as an “abstract query” because the query is composed from logical fields rather than by direct reference to the underlying physical data entities in the databases 156-157. As a result, abstract queries may be defined that are independent of the particular underlying data representations (e.g., a relational database and SQL schema). The application query specification 142 may define both the criteria available for data selection (selection criteria 204) and the fields that may be returned to a user (return data specification 206) based on the selection criteria 204.

In one embodiment, the logical fields specified by application query specification 142, and used to compose abstract query 202, are defined by the data repository abstraction component 148. In general, the data repository abstraction component 148 exposes a set of logical fields that may be used within an abstract query. The logical fields are defined independently of the underlying data representation being used in the databases 156-157, thereby allowing a user to compose queries that are loosely coupled to the underlying data representation. In addition, logical fields may be defined over an abstract function. Abstract functions are invoked to retrieve data using a set of input fields. The inputs fields of an abstract function may comprise other logical fields defined in the data repository abstraction component 148, or other abstract functions. Thus, the input to one abstract function may be the output from another. Further, the function evaluation method actually invoked is dependent upon the particular data inputs supplied to the abstract function.

FIG. 2B illustrates one embodiment of a data repository abstraction component 148 that includes a plurality of logical field specifications 208₁₋₅ (five shown by way of example), collectively referred to as field specifications 208. Specifically, a field specification 208 is provided for each logical field available for composition of an abstract query. Each field specification 208 identifies a logical field name 210₁, 210₂, 210₃, 210₄, 210₅ (collectively, field name 210) and an associated access method 212₁, 2142, 212₃, 212₄, 212₅ (collectively, access method 212). The access methods map a logical field to a particular physical data representation (e.g., representations 214₁, 214₂ . . . 214_{N} illustrated in FIG. 2A). By way of illustration, two data representations are shown, an XML data representation 214₁ and a relational data representation 214₂. However, the physical data representation 214_{N} indicates that any other data representation, known or unknown, is contemplated.

Depending upon the number of different logical fields supported by the data abstraction layer, any number of access methods are contemplated. For example, one embodiment provides access methods for simple fields, filtered fields, composed fields, and abstract functions. The field specifications 208₁, 208₂ and 208₅ exemplify simple field access methods 212₁, 212₂, and 212₅, respectively. Simple fields map directly to a particular entity in the underlying physical data representation (e.g., a simple field may map to a table and column of a relational database). Illustratively, the simple field access method 212₁ shown in FIG. 2B maps the logical field name 210₁ (“FirstName”) to a column named “f_name” in a table named “contact”. The field specification 208₃ exemplifies a filtered field access method 212₃. Filtered fields identify an associated physical entity and provide rules used to define a particular subset of items within the physical data representation. An example is provided in FIG. 2B in which the filtered field access method 212₃ maps the logical field “AnytownLastName” to a physical entity in a column named “I_name” in a table named “contact” and defines a filter for individuals in the city of Anytown. Another example of a filtered field is a New York ZIP code logical field that maps to a physical representation of ZIP codes and restricts the data only to those ZIP codes defined for the state of New York.

The field specification 208₄ exemplifies a composed field access method 212₄. Composed access methods compute a value from one or more fields (either abstract fields or data from a database) using an expression supplied as part of the access method definition. In this way, information that does not exist in the underlying database may be computed. In the example illustrated in FIG. 2B, the composed field access method 212₃ maps the logical field name 210₃ “AgeInDecades” to “AgeInYears/10”. Other illustrative examples of a composed field includes is a sales tax field that is composed by multiplying a sales price field by a sales tax rate or a name composed by concatenating individual first name and last name fields.

By way of example, field specifications 208 of data repository abstraction component 148 shown in FIG. 2 are representative of logical fields mapped to data represented in the relational data representation 214₂. However, other instances of the data repository abstraction component 148 map logical fields to other physical data representations, such as XML. Further, in one embodiment, a data repository abstraction component 148 is configured with some logical fields that map to data values using a functional access method. Detailed examples of functional access methods are described below.

An illustrative abstract query corresponding to the abstract query 202 shown in FIG. 2 is shown in Table I below. In this example, the data repository abstraction 148 is defined using XML.

TABLE I
QUERY EXAMPLE

| 001 | <?xml version=“1.0”?> |
|---|---|
| 002 | <!--Query string representation: (FirstName = “Mary” AND |
| | LastName = |
| 003 | “McGoon”) OR State = “NC”--> |
| 004 | <QueryAbstraction> |

| | |
|---|---|
| 005 | <Selection> |

| | |
|---|---|
| 006 | <Condition internalID=“4”> |

| 007 | <Condition field=“FirstName” operator=“EQ” |
|---|---|
| | value=“Mary” |

| | |
|---|---|
| 008 | internalID=“1”> |

| 009 | <Condition field=“LastName” operator=“EQ” |
|---|---|
| | value=“McGoon” |

| | |
|---|---|
| 010 | internalID=“3” relOperator=“AND”></Condition> |

| 011 | </Condition> |
|---|---|
| 012 | <Condition field=“State” operator=“EQ” value=“NC” |
| | internalID=“2” |

| | |
|---|---|
| 013 | relOperator=“OR”></Condition> |

| | |
|---|---|
| 014 | </Selection> |
| 015 | <Results> |

| | |
|---|---|
| 016 | <Field name=“FirstName”/> |
| 017 | <Field name=“LastName”/> |
| 018 | <Field name=“Street”/> |

| | |
|---|---|
| 019 | </Results> |

| | |
|---|---|
| 020 | </QueryAbstraction> |

The abstract query shown in Table I includes a selection specification (lines 005-014) containing selection criteria and a results specification (lines 015-019). In one embodiment, a selection criterion consists of a field name (for a logical field), a comparison operator (=, >, <, etc) and a value expression (what is the field being compared to). In one embodiment, result specification is a list of abstract fields that are to be returned as a result of query execution. A result specification in the abstract query may consist of a field name and sort criteria.

An illustrative instance of a data repository abstraction component 148 corresponding to the abstract query in Table I is shown in Table II below. For this example, the data repository abstraction component 148 is defined using XML.

TABLE II
DATA REPOSITORY ABSTRACTION EXAMPLE

| | |
|---|---|
| 001 | <?xml version=“1.0”?> |
| 002 | <DataRepository> |

| | |
|---|---|
| 003 | <Category name=“Demographic”> |

| | |
|---|---|
| 004 | <Field queryable=“Yes” name=“FirstName” |

displayable=“Yes”>

| | |
|---|---|
| 005 | <AccessMethod> |

| | |
|---|---|
| 006 | <Simple columnName=“f_name” |

tableName=“contact”></Simple>

| | |
|---|---|
| 007 | </AccessMethod> |
| 008 | <Type baseType=“char”></Type> |

| | |
|---|---|
| 009 | </Field> |
| 010 | <Field queryable=“Yes” name=“LastName” |

displayable=“Yes”>

| | |
|---|---|
| 011 | <AccessMethod> |

| | |
|---|---|
| 012 | <Simple columnName=“l_name” |

tableName=“contact”></Simple>

| | |
|---|---|
| 013 | </AccessMethod> |
| 014 | <Type baseType=“char”></Type> |

| | |
|---|---|
| 015 | </Field> |
| 016 | <Field queryable=“Yes” name=“State” |

displayable=“Yes”>

| | |
|---|---|
| 017 | <AccessMethod> |

| | |
|---|---|
| 018 | <Simple columnName=“state” |

tableName=“contact”></Simple>

| | |
|---|---|
| 019 | </AccessMethod> |
| 020 | <Type baseType=“char”></Type> |

| | |
|---|---|
| 021 | </Field> |

| | |
|---|---|
| 022 | </Category> |

| | |
|---|---|
| 023 | </DataRepository> |

This illustration includes XML elements describing some of the fields shown in FIG. 2B.

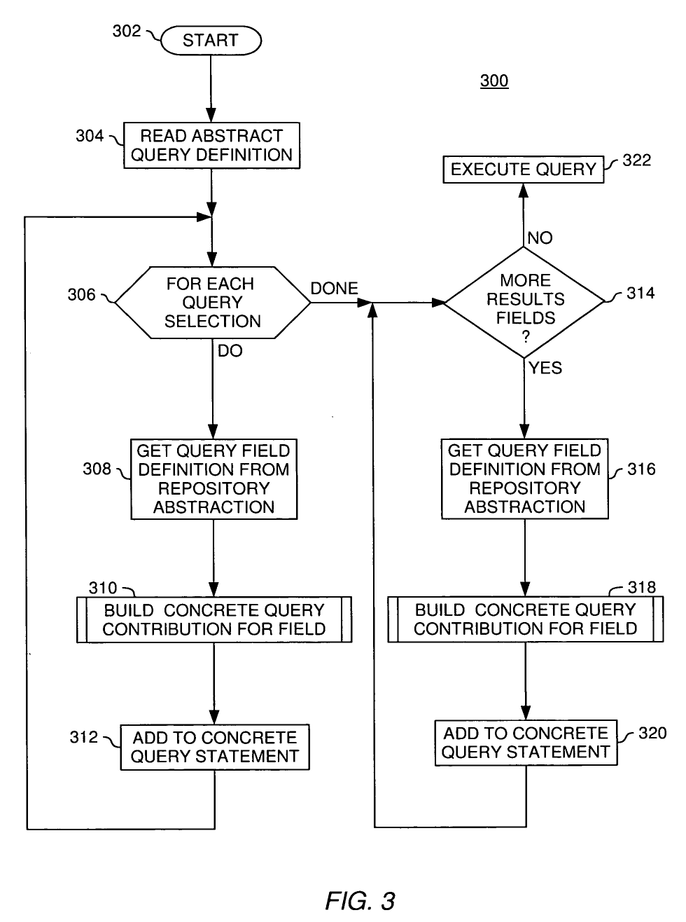

FIG. 3 illustrates an exemplary runtime method 300 exemplifying one embodiment of the operation of the runtime component 150. The method 300 process an abstract query by mapping logical fields included in the abstract query to the underlying data using the access method specified for each query. Operations 300 begin at step 302 when the runtime component 150 receives (as input) an abstract query (such as the abstract query 202 shown in FIG. 2). At step 304, the runtime component 150 parses the the abstract query and locates individual selection criteria and desired result fields. At step 306, the runtime component 150 enters a loop (comprising steps 306, 308, 310 and 312) for processing each query selection criteria statement present in the abstract query, thereby building a data selection portion of a concrete query. In one embodiment, a selection criterion consists of a field name (of a logical field), a comparison operator (=, >, <, etc) and a value expression (compared with the field selection).

At step 308, the runtime component 150 uses the field name from a selection criterion of the abstract query to look up the definition of the field in the data repository abstraction 148. As noted above, the field definition includes a definition of the access method used to access the physical data associated with the field. The runtime component 150 then builds (step 310) a concrete query contribution for the logical field being processed. As used herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from a physical data repository, represented by the databases 156-157 shown in FIG. 1. The concrete query contribution generated for the current field is then added to a concrete query statement. The method 300 then returns to step 306 to begin processing for the next field of the abstract query. Accordingly, the process entered at step 306 is iterated for each data selection field in the abstract query, thereby contributing additional content to the eventual query to be performed.

After building the data selection portion of the concrete query, the runtime component 150 identifies the information to be returned as a result of query execution. As described above, in one embodiment, the abstract query defines a list of abstract fields that are to be returned as a result of query execution, referred to herein as a result specification. A result specification in the abstract query may consist of a field name and sort criteria. Accordingly, the method 300 enters a loop at step 314 (defined by steps 314, 316, 318 and 320) to add result field definitions to the concrete query being generated. At step 316, the runtime component 150 looks up a result field name (from the result specification of the abstract query) in the data repository abstraction 148 and then retrieves a result field definition from the data repository abstraction 148 to identify the physical location of data to be returned for the current logical result field. The runtime component 150 then builds (as step 318) a concrete query contribution (of the concrete query that identifies physical location of data to be returned) for the logical result field. At step 320, concrete query contribution is then added to the concrete query statement. Additionally, as described in greater detail below, some logical fields of the data repository abstraction component 148 may map to an abstract function. The runtime component 150 is configured to resolve the inputs for an abstract function and to invoke the abstract function over the provided inputs.

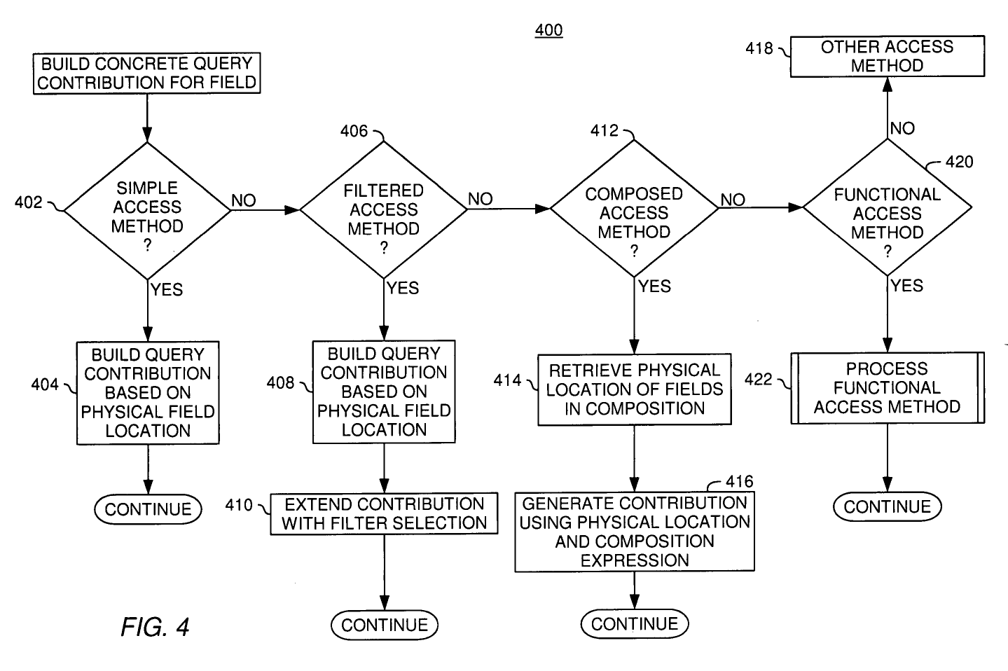

One embodiment of a method 400 for building a concrete query contribution for a logical field according to steps 310 and 318 of FIG. 3 is described with reference to FIG. 4. At step 402, the method 400 queries whether the access method associated with the current logical field is a simple access method. If so, the concrete query contribution is built (step 404) based on physical data location information (step 405). Processing then continues according to method 300 described above. Otherwise, processing continues to step 406 to query whether the access method associated with the current logical field is a filtered access method. If so, the concrete query contribution is built (step 408) based on physical data location information for some physical data entity. At step 410, the concrete query contribution is extended with additional logic (filter selection) used to subset data associated with the physical data entity. Processing then continues according to method 300 described above.

If the access method is not a filtered access method, processing proceeds from step 406 to step 412 where the method 400 queries whether the access method is a composed access method. If the access method is a composed access method, the physical data location for each sub-field reference in the composed field expression is located and retrieved at step 414. At step 416, the physical field location information of the composed field expression is substituted for the logical field references of the composed field expression, whereby the concrete query contribution is generated. Processing then continues according to method 300 described above.

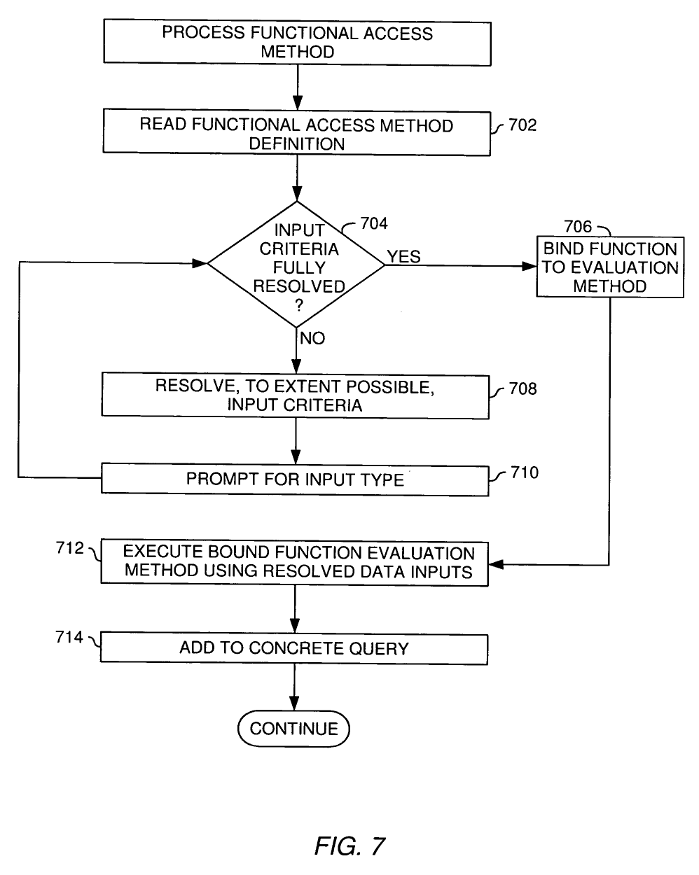

If the access method identified for a logical field is a functional access method, at step 420 the runtime component resolves the inputs for the abstract query and binds the abstract function to a particular function based on the resolved inputs at step 422. This step is further described in conjunction with FIG. 7.

If the access method is not a composed access method, processing proceeds from step 420 to step 418. Step 418 is representative of any other access methods types contemplated as embodiments of the present invention. Those skilled in the art will recognize that embodiments are contemplated in which less then all the access methods described herein are implemented. For example, in a particular embodiment only simple access methods are used. In another embodiment, only simple access methods and filtered access methods are used.

For some logical fields, conditions, or return values, it may be necessary to perform a data conversion if a logical field specifies a data format different from the underlying physical data. In one embodiment, an initial conversion is performed for each respective access method when building a concrete query contribution for a logical field according to the method 400. For example, the conversion may be performed as part of, or immediately following, the steps 404, 408 and 416. A subsequent conversion from the format of the physical data to the format of the logical field is performed after the query is executed at step 322. Of course, if the format of the logical field definition is the same as the underlying physical data, no conversion is necessary.

One embodiment extends the data repository abstraction component 148 to include description of a multiplicity of data sources that can be local and/or distributed across a network environment. The data sources may use a multitude of different data representations and data access techniques. In one embodiment, this is accomplished by configuring the access methods of the data repository abstraction component 148 with a location specification that identifies (for at least one logical field) a remote location where the data associated with the logical field resides. Additional examples of such embodiments are described in a commonly owned, currently pending application, “Remote Data Access and Integration of Distributed Data Sources through Data Schema and Query Abstraction,” Ser. No. 10/131,984, filed Apr. 25, 2002, incorporated in entirety by reference.

Abstract Functions

A data abstraction layer that provides users with a set of logical fields used to compose abstract queries has been described. The queries are resolved by a runtime component 150 into a concrete query that may be issued to retrieve, add, and modify data stored in databases 156 and 157. As described, the logical fields include a logical field name and an access method. The access method is used to resolve the abstraction from the logical field into a concrete query statement according to an actual database schema. Logical fields, however, are not limited to a one-to-one relationship between a logical field and an access method used to map between the abstraction of a logical field and an underlying physical database.

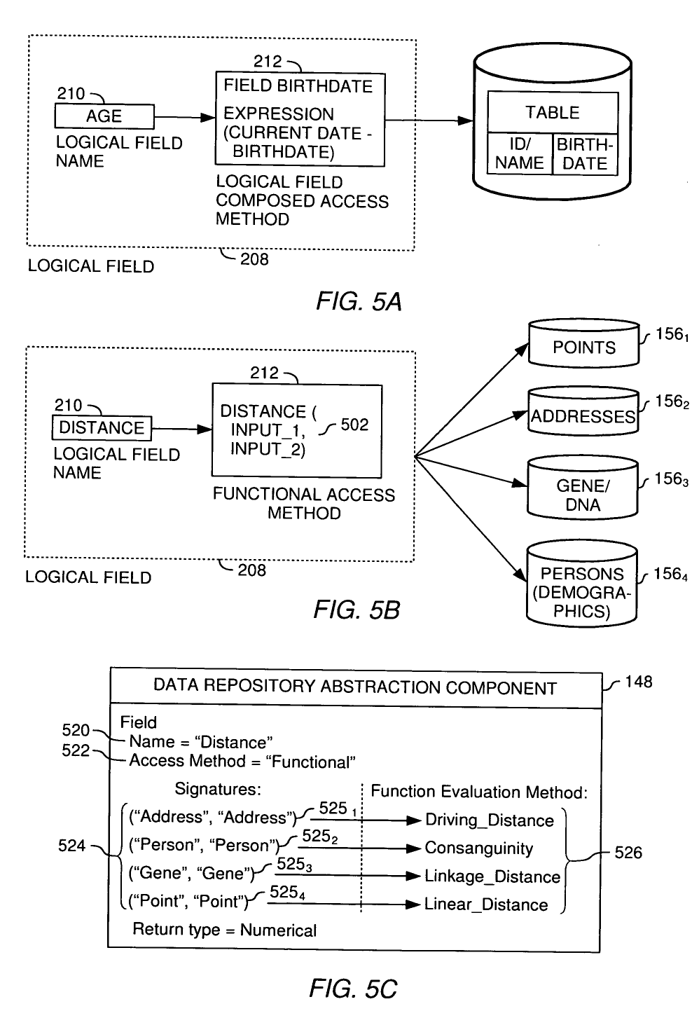

For example, FIG. 5A illustrates data flow from a logical field 210, to a corresponding access method 212, and then to an underlying data repository 156. As illustrated, the access method 212 uses a composed access method to generate data that is not directly available from the underlying data repository 156. In this example, an “age” logical field is composed according to the expression “((Current Date)-(Birth Date))” to calculate the age of an individual. Although useful, the “age” logical field is limited to retrieving an “age” value for individuals.

FIG. 5B illustrates a functional view of a logical field 208, with the logical field name “distance” 210 and illustrates the corresponding interaction between the logical field 208 and the underlying physical data repositories 156₁₋₄. In this illustration, however, the access method 212 uses a functional access method to retrieve data in a one-to-many relationship for the logical field 208. The data retrieved for the logical field depends upon the data supplied to the logical “distance” logical field.

In one embodiment, a functional access method includes a definition for a set of one or more signatures 502. Each signature 502 specifies a set of inputs that may be supplied to the abstract function. The signatures 502 differentiate how the input data is processed by the runtime component 150 to resolve the abstract function into result data. The inputs used for the abstract function may identify other objects from the data abstraction layer (also referred to as a data repository abstraction component). In particular, the inputs may comprise logical fields defined in the data repository abstraction component 148, including other logical fields that specify a functional access method.

As illustrated, logical field 208 specifies a functional access method. Specifically, a “distance” abstract function capable of retrieving data from underlying physical data sources 156₁₋₄. Illustratively, four different input signatures may be used with the “distance” logical field is illustrated. The four different input signatures shown in FIG. 5B includes points, addresses, genes, and persons as input data.

The “distance” abstract function takes two inputs and returns a numerical value. The actual calculation, however, depends on the inputs provided to the abstract function. If two point objects are used as data inputs, then data from database 156₁ is used to determine a straight-line distance. If two addresses are used, then the abstract function returns the driving distance between the two input addresses using data from database 156₂. Similarly, using the appropriate inputs, the “distance” logical field 208 may return a gene linkage value from database 156₃ or the consanguinity between two individuals using data from database 156₄. Note, that the inputs themselves (i.e., a point, an address, a gene, or an individual in this example) may comprise a logical field that maps to the data in databases 156₁₋₄ using an access method. Further, the access method for an input field to an abstract function itself may comprise another abstract function.

Table III illustrates an embodiment of a portion of data repository abstraction component 148 that includes a logical field specification for the “distance” logical field 208 from FIG. 5B. In this example, the data repository abstraction 148 is defined using XML.

TABLE III
ABSTRACT FUNCTION EXAMPLE

| | |
|---|---|
| 001 | <?xml version=“1.0”?> |
| 002 | <Field name = “Distance”> |

| | |
|---|---|
| 003 | <AccessMethod methodType = “Functional”> |

| | |
|---|---|
| 004 | <Signature> |

| | |
|---|---|
| 005 | <input type = “address”/> <input type = “address”/> |
| 006 | <binding type = SQL name = “DrivingDistance”/> |

| | |
|---|---|
| 007 | </Signature> |
| 008 | <Signature> |

| | |
|---|---|
| 009 | <input type = “point”/> <input type = “point”/> |
| 010 | < binding type = SQL name = “LinearDistance”/> |

| | |
|---|---|
| 011 | </Signature> |
| 012 | <Signature> |

| | |
|---|---|
| 013 | <input type = “gene”/> <input type = “gene”/> |
| 014 | < binding type = SQL name = “LinkageDistance”/> |

| | |
|---|---|
| 015 | </Signature> |
| 016 | <Signature> |

| | |
|---|---|
| 017 | <input type = “person”/> <input type = “person”/> |
| 018 | < binding type = SQL name = “Consanguinity”/> |

| | |
|---|---|
| 019 | </Signature> |

| | |
|---|---|
| 020 | <Type baseType = “numerical”\> |
| 021 | </AccessMethod> |

| | |
|---|---|
| 022 | </Field> |

Lines 003-21 illustrate a definition for the “distance” functional access method example described above. The definition includes the four signatures illustrated in FIG. 5B for using “address, point”, “gene,” and “person” as examples of input types 525. Line 20 shows the return type for the “distance” logical field as being a numerical value. This value may be used, for example, as part of the selection criteria for an abstract query (e.g., a selection criteria of “distance<5”). Lines 6, 10, 14, and 18 each illustrate a binding attribute. This attribute is used to select from alternative execution logic based on the signatures that are defined for the abstract function. That is, the function actually invoked for the “distance” abstract function example is determined by inspecting the inputs actually provided during query processing.

FIG. 5C illustrates a data repository extraction component 148 that includes logical field specification 208 for the distance logical field. The field specification 208, includes a field name 520: “distance” and access method 522: “functional”. Additionally, field specification 208 includes the four signatures 524 and input types 525 illustrated in Table III and the return type “numerical” indicating the return type for the logical field. The input types 525 may specify other logical fields in the data repository abstraction component 148. Alternatively, in one embodiment, input types 525 may specify groups of related logical fields. In the example illustrated in FIG. 5C, the “person” input type specifies a set of logical fields (e.g., patient, research participant, doctor, lab technician, among others) where each element of the group ultimately identifies an individual.

FIG. 5C further illustrates function evaluation methods 526 corresponding to the “binding” attribute for the abstract function shown above in Table III. The function evaluation method directs the runtime component 150 to the execution logic for the -abstract function based on the different signatures. For example, illustrative function evaluation methods include: (i) a query language expression using built-in functions supported by the underlying query language for the database (e.g., SQL functions), (ii) a query language statement that supports the use of user defined functions defined to the query environment (e.g., an SQL User Defined Function Call (UDF)), or (iii) other procedural invocation methods supported by the underlying data repository. As illustrated in Table II, each of the signatures is bound to a specific SQL function associated with a particular relational database.

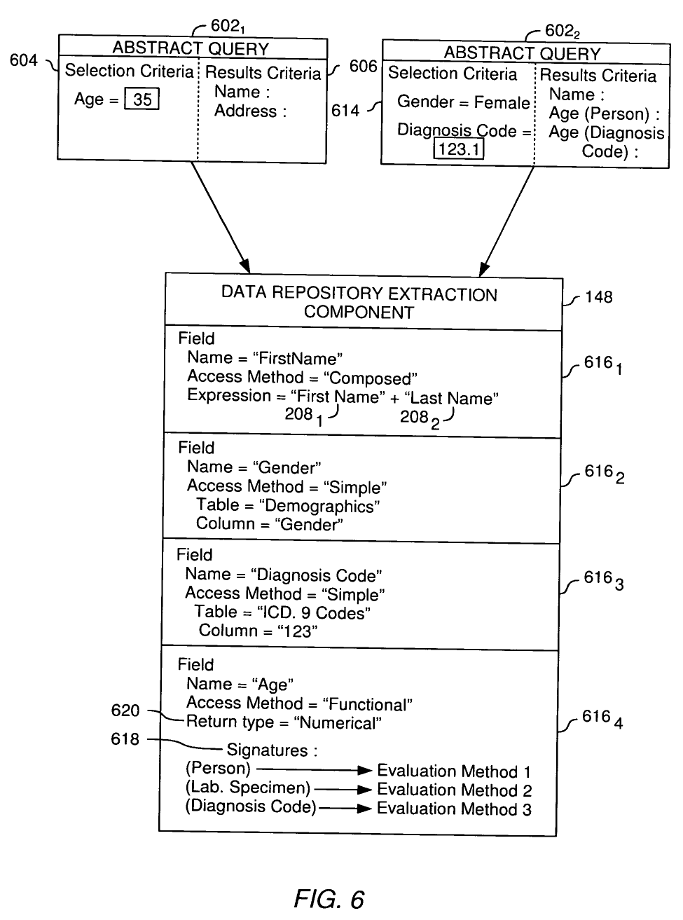

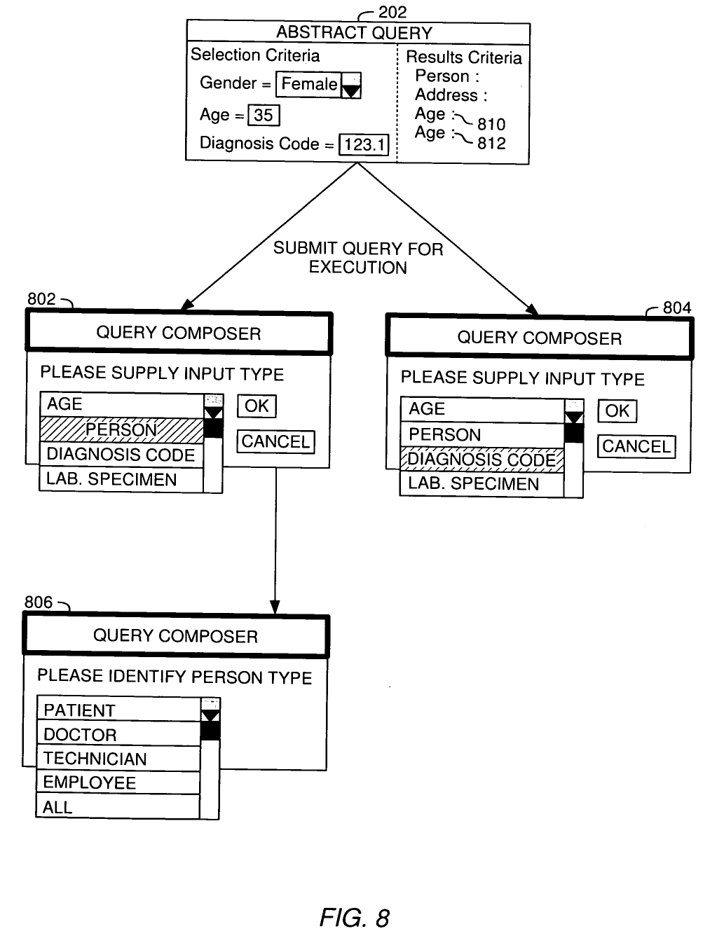

FIG. 6 illustrates two abstract queries 602₁ and 602₂ that include a logical field defined over an abstract function. Query 602₁ illustrates the “age” logical field used as part of the selection criteria 604 for abstract query 602₁, whereas query 602₂ illustrates the “age” logical field used as part of the results criteria 608. In addition, abstract query 602₂ illustrates the polymorphic character of an abstract function. That is, results criteria 608 includes two instances of the “age” logical field, one using “person” as input data and the other using “diagnosis code.” Processing of abstract query 602₂ is described below with reference to FIGS. 7 and 8.

Both abstract query 602₁ and 602₂ are composed from logical fields included in data repository abstraction component 648 (and some logical fields from FIG. 2B). Abstract query 602₁ includes a single selection criteria that specifies a condition of “age=35”. In one embodiment, because the selection criteria itself does not identify the input type used for the “age” field 603, the runtime component 150 may be configured to prompt the user (e.g., using a GUI dialog box) to supply the desired input type during query processing (e.g., as part of step 422 from FIG 4).

Data repository abstraction component 648 includes two logical fields that specify a simple access method (fields 616₂ and 616₃). Data repository abstraction component 648 also includes logical field definition 616₁ that specifies a composed access method. Note that the composed access method from field 616₁ uses two logical fields (208₁ and 208₂) and an expression to define result data. The “age” logical field 616₃ is defined using a functional access method. Accordingly, the age logical field definition 616₃ defines a set of one or more signatures 618 and a return type 620.

FIG. 7 illustrates one embodiment of a method for processing abstract queries that include logical fields defined over an abstract function (e.g. abstract query 602₂). The operations begin at step 702 when the runtime component 150 encounters a functional access method while processing an abstract query (e.g., while performing the methods illustrated in FIGS. 3 and 4). Note, however, the order in which logical fields of an abstract query are processed may vary and need not proceed in a linear fashion through each element included in an abstract query. For example, in one embodiment, the runtime component may process all logical fields included in a query that specify a functional access method. Additionally, sometimes a certain order of processing will be dictated by the query structure itself (e.g., where the output from one abstract function is used as the input to another).

At step 702, the runtime component reads the definition of the abstract query from the data repository abstraction component. For example, FIG. 8 illustrates an abstract query 602₂ that includes three logical fields defined over abstract functions. While processing query 602₂, the selection criteria is used to construct a query contribution for the “gender=female” and “diagnosis code=123.2” predicates. While processing the “age=35” criterion, the runtime component 150 retrieves the definition for the “age” field from data repository abstraction component 648 (e.g., field specification 616₄ from FIG. 6). Accordingly, the runtime component 150 becomes aware of each unique signature defined by the logical field definition for the abstract function.

Next, at step 704, after retrieving the abstract function definition, runtime component 150 determines whether the inputs necessary to process the abstract function are fully resolved. That is, the runtime component 150 determines whether it can unambiguously determine which signature is being used, and thus, a corresponding function evaluation method to bind to the input data. For example, each signature defined for the “distance” abstract function illustrated in FIG. 5C takes two input items. As defined, however, it takes two input items of the same type. Thus, by resolving one, the other may be unambiguously determined as the same type as the first.

If the inputs are fully resolved, processing continues to step 706. Otherwise, the method proceeds to step 708 and resolves, to the extent possible, the input data for the abstract function. Returning to the “age=35” condition 814 illustrated in abstract query 602₂, at step 704, the runtime component may determine from the context of the “gender=female” condition that the “age” selection field 814 should be bound to the “person” function evaluation method.

In one embodiment, if the runtime component 150 cannot determine the input types for the abstract function, then a user may be prompted to supply input data types. This process (i.e., steps 708 and 710) repeats until the inputs to the abstract function are fully resolved. For example, GUI dialog boxes 802 and 804 illustrate prompts that may be displayed to a user allowing the user to select among different input types for the fields 810 and 812 of abstract the “age” abstract function. In addition, dialog box 806 illustrates the “person” logical field that refers to a set of related logical fields that can be further restricted, either as part of a logical field or as an input to an abstract function based on input supplied in response to the prompt.

Referring again to FIG. 7, after resolving the input types, the runtime component binds a function evaluation method to the abstract function at step 706. At step 711, the runtime component may invoke the execution logic (e.g., database function, user defined function, or UDF call of the bound function evaluation method). However, once the inputs for the abstract function are fully resolved (and the function evaluation method is bound), further processing may be required before executing the execution logic. That is, binding a function to an evaluation method based on a resolved signature is not the same as actually performing the function evaluation logic. The runtime component 150 is responsible for determining when to execute the abstract function, and how to do so most efficiently.

For example, if one of the inputs is itself an abstract function, then this input may need to be bound to a function evaluation method before processing the “outer” abstract function. Accordingly, the runtime component may process and bind an innermost nested abstract function to a function evaluation method before processing any outer nested functions. After processing any nested abstract functions, the method proceeds to step 712.

Next, at step 712, the runtime component 150 generates a query contribution for the logical field that is defined over an abstract function (or possibly for a nested abstract function). This may comprise generating a concrete query contribution for the resolved abstract function, or may comprise determining a result value for the abstract function. At step 714, the query contribution or result value (depending on the return type of the abstract function) is added to the query contribution for the logical field. For example, if the abstract field is used as part of a condition, (e.g., logical field 814), then during runtime the runtime component 150 generates a query that will invoke the abstract function bound to a function evaluation method to determine the age of each individual returned from the “gender=female” selection criterion limiting the results to those that satisfy the condition “age=35”. Processing of the abstract query continues until each logical field as been processed by the runtime component 150.

### CONCLUSION

Abstract functions extend the abstract data layer by decoupling an expression from a one-to-one relationship between an access method and underlying physical data. Abstract functions are “late bound” to a function evaluation method. That is, the appropriate evaluation method is not determined until the function is actually invoked. The binding of an abstract function may be determined contextually from query content, or from input provided by a user in response to a prompt for information. Abstract functions are polymorphic because the same function may operate using many different data input types. Different input groups are used to determine which functional evaluation method to bind to the abstract function. Additionally, abstract functions are generally transparent to the end user. That is, they are presented to the user as an additional object that may be used to compose queries of data represented by the abstract data layer undifferentiated from other data elements used to compose an abstract query.

While the foregoing is directed to embodiments of the present invention, other and further embodiments of the invention may be devised without departing from the basic scope thereof, and the scope thereof is determined by the claims that follow.

What is claimed is:

1. A method for extending data access and analysis capabilities of an abstract database using abstract, polymorphic functions, comprising:
providing an abstract query specification that defines a plurality of logical fields used to compose an abstract query, wherein the definition for each logical field specifies (i) a name used to identify the logical field, (ii) an access method that maps the logical field to data in an underlying data repository, and wherein the access method specified for at least one logical field comprises a functional access method that specifies at least a group of data input types for an abstract function, and wherein the abstract function is bound to a function evaluation method based on the particular group of data input types specified for the abstract function by an abstract query.

2. The method of claim 1, wherein each data input from the at least a group of data inputs is selected from (i) the plurality of logical fields and (ii) a plurality of identifiers, wherein each identifier represents a set of related logical fields.

3. The method of claim 1, further comprising, prompting a user submitting an abstract query for processing to identify the particular group of data input types for the abstract function using a graphical user interface.

4. The method of claim 3, further comprising, binding the abstract function, during the runtime processing of the particular abstract query, to a function evaluation method based on the particular group of data input types identified by the user, and executing the abstract function using the identified data input types and bound function evaluation method to determine a result value for the abstract function.

5. The method of claim 1, wherein a function evaluation method comprises one of: (i) a function supported by the underlying data repository (ii) a query language statement that supports the invocation of user defined functions, (iii) an abstract query, and (iv) other procedural invocation methods supported by the underlying data repository.

6. The method of claim 1 further comprising binding the abstract function, during the runtime processing of the particular abstract query, to a function evaluation method based on the particular group of data input types and executing the abstract function using the identified data input types and bound function evaluation method.

7. A method for processing an abstract query that includes a logical field defined over an abstract function, comprising:
receiving, from a requesting entity, an abstract query composed from a plurality of logical fields defined in a data abstraction layer, wherein the definition for each logical field specifies (i) a name, and (ii) an access method that maps the logical field to data in an underlying data repository, and wherein the access method specified for at least one of the plurality logical fields query specifies a functional access method that specifies a group data input types for an abstract function, and wherein the abstract function is bound to a function evaluation method while processing the abstract query based on the data input types;
transforming the abstract query into a query consistent with a physical representation of the data in the underlying data repository using the access methods specified for each logical field included in the abstract query;
binding the abstract function to a function evaluation method invoked to obtain a result value for the at least one logical field; and
invoking the function evaluation method to determine a result value for the functional access method.

8. The method of claim 7, wherein transforming the abstract query into a query consistent with a physical representation of the data comprises generating a query contribution for each logical field and further comprising, merging the query contributions and the result value determined for the abstract function into a completed query, and issuing the completed query against the data in the underlying data repository.

9. The method of claim 7, wherein each data input from the group of data input types is selected from (i) the plurality of logical fields and (ii) a plurality of identifiers, wherein each identifier represents a set of logical fields.

10. The method of claim 7, further comprising, prompting a user to identify the particular data input types for the abstract function using a graphical user interface.

11. The method of claim 10, wherein binding the abstract function to a function evaluation method occurs during the runtime processing of the abstract query.

12. The method of claim 7, wherein a function evaluation method comprises one of: (i) a function supported by the underlying data repository (ii) a query language statement that supports the invocation of user defined functions, (iii) an abstract query, and (iv) other procedural invocation methods supported by the underlying data repository.

13. A system for processing an abstract query, comprising:
a data abstraction layer configured to provide a set of logical fields used to compose an abstract query; wherein each logical field specifies (i) a name used to identify the logical field, (ii) an access method that maps the logical field to data in an underlying data repository, wherein the access method specified for at least one logical field comprises a functional access method, wherein (i) the definition for the functional access method specifies at least a group of data input types for an abstract function, and wherein (ii) the abstract function is bound to a function evaluation method while processing the abstract query based on a particular group of data input types specified for the abstract function by an abstract query;
a runtime component configured to receive the abstract query, and in response, (i) to generate a query contribution for each logical field included in the abstract query and (ii) to bind the abstract function specified by the at least one logical field to a functional evaluation method based on the particular group of data input types specified for the abstract function.

14. The system of claim 13, further comprising, prompting a requesting entity supplying an abstract query for processing to identify a particular set of data input types for the abstract query using a graphical user interface.

15. The system of claim 13, wherein the function evaluation method comprises one of a query language expression using built-in functions supported by an underlying data repository (ii) a query language statement that supports the use of user defined functions defined to the query environment, (iii) an abstract query or (iv) other procedural invocation methods supported by the underlying data repository.

16. A computer-readable medium containing a program which, when executed by a processor, performs operations of extending data access and analysis capabilities via abstract, polymorphic functions, the operations comprising:
providing an abstract query specification that defines a plurality of logical fields used to compose an abstract query, wherein the definition for each logical field specifies (i) a name used to identify the logical field, (ii) an access method that maps the logical field to data in an underlying data repository, and wherein the access method specified for at least one logical field comprises a functional access method that specifies at least a group of data input types and an abstract function, and wherein the abstract function is bound to a function evaluation method based on the particular group of data input types specified for a abstract query;
receiving, from a requesting entity, the abstract query composed from a plurality of logical fields;
transforming the abstract query into a query consistent with a physical representation of the data in the underlying data repository;
binding the abstract function to a function evaluation method invoked to obtain a result value for the at least one logical field; and
invoking the function evaluation method to determine the result value for the functional access method.

17. The computer-readable medium of claim 16, wherein transforming the abstract query into a query consistent with a physical representation of the data comprises generating a query contribution for each logical field and further comprising, issuing the completed query against the data in the underlying data repositories.

18. The computer-readable medium of claim 16, wherein each data input the group of data input types is selected from (i) the plurality of logical fields and (ii) a plurality of identifiers, wherein each identifier represents a set of logical fields.

19. The computer-readable medium of claim 16, wherein transforming the abstract query into a query consistent with a physical representation of the data comprises generating a query contribution for each logical field and further comprising, merging the query contributions and result value into a completed query, and issuing the completed query against the data in the underlying data repository.

20. The computer-readable medium of claim 16, further comprising, prompting a user to identify the particular group of data input types for the abstract function for the at least one logical field using a graphical user interface.

21. The computer-readable medium of claim 16, wherein binding the abstract function to a function evaluation method occurs during the runtime processing of the abstract query.
